(19) United States
(12) Patent Application Publication
(10) Pub. No.: US 2014/0000408 A1
(43) Pub. Date: Jan. 2, 2014

(54) ACCELERATOR APPARATUS FOR VEHICLE

(71) Applicant: DENSO CORPORATION, Kariya-city (JP)

(72) Inventors: Takehiro SAITO, Anjo-city (JP); Masahiro MAKINO, Kariya-city (JP)

(21) Appl. No.: 13/927,741

(22) Filed: Jun. 26, 2013

(30) Foreign Application Priority Data
Jun. 27, 2012 (JP) 2012-144062

(51) Int. Cl. G05G 1/44

(52) U.S. Cl. CPC G05G 1/44
USPC 74/513

(57) ABSTRACT

A rotatable body is rotatable integrally with the shaft and includes a boss portion and a limiting portion. The boss portion is fixed to an outer peripheral wall of the shaft. The limiting portion is received in an internal space of a support member and is connected to the boss portion. The limiting portion limits a rotational angle of the boss portion in an accelerator closing direction when a contact surface of the limiting portion contacts an inner wall of the support member at an accelerator-full-closing time. The contact surface of the rotatable body is a curved surface.

### CROSS REFERENCE TO RELATED APPLICATION

This application is based on and incorporates herein by reference Japanese Patent Application No. 2012-144062 filed on Jun. 27, 2012.

### TECHNICAL FIELD

The present disclosure relates to an accelerator apparatus for a vehicle.

### BACKGROUND

A known accelerator apparatus controls an acceleration state of a vehicle based on the amount of depression of an accelerator pedal that is depressed by a driver of the vehicle. The accelerator pedal is rotatably supported through a shaft, which is in turn supported by a support member. A rotational angle of the shaft corresponds to movement of the accelerator pedal and is sensed with a rotational angle sensor. At a time (hereinafter referred to as an accelerator-full-closing time) of placing the accelerator pedal in an accelerator full-closing position, at which the accelerator pedal is fully released by the driver, a limiting portion, which is rotated integrally with the shaft, contacts the support member of the accelerator apparatus to limit the rotational angle of the shaft to a predetermined angle. JP2004-090755A recites one such an accelerator apparatus. In this accelerator apparatus, a resilient member, which is resiliently deformable, is installed to an inner wall of the support member, to which the limiting portion contacts. With this construction, it is possible to reduce a knock sound, which would be generated when the limiting portion hits the support member.

In general, in a case where a distance between a point on a contact surface of the limiting member, which can contact the inner wall of the support member, and a point on a rotational axis of the shaft is made constant for a long period of time, the rotational angle of the shaft, which is sensed with the rotational angle sensor, becomes constant at the accelerator-full-closing time. However, in the accelerator apparatus of JP2004-090755A, each of the limiting portion and the resilient member is configured into a planar form. Therefore, in a case where the position of the rotational axis of the shaft is deviated from its initial position due to, for example, creep strain, an end part of the limiting portion may possibly contact the inner wall of the support member at the accelerator-full-closing time. A distance between the end part of the limiting portion and the point on the rotational axis of the shaft is largely changed in comparison to the distance between the point on the contact surface, which can contact the inner wall of the support member, and the point on the rotational axis of the shaft. Therefore, the rotational angle of the shaft at the accelerator-full-closing time in the accelerator apparatus, which has been used for a long period of time, differs from the rotational angle of the shaft at the accelerator-full-closing time in the accelerator apparatus, which is still new (i.e., in an initial state, such as a brand-new state of the accelerator apparatus). Thereby, the rotational angle, which is sensed with the rotational angle sensor at the accelerator-full-closing time, becomes unstable (i.e., variable).

### SUMMARY

The present disclosure addresses the above disadvantages. According to the present disclosure, there is provided an accelerator apparatus for a vehicle. The accelerator apparatus includes a support member, a shaft, a rotatable body, a pedal arm, a rotational angle sensing device and an urging device. The support member is installable to a body of the vehicle. The shaft is rotatably supported by the support member. The rotatable body is rotatable integrally with the shaft and includes a boss portion and a limiting portion. The boss portion is fixed to an outer peripheral wall of the shaft. The limiting portion is received in an internal space of the support member and is connected to the boss portion. The limiting portion limits a rotational angle of the boss portion in an accelerator closing direction when a contact surface of the limiting portion contacts an inner wall of the support member at an accelerator-full-closing time. The pedal arm has one end portion, which is fixed to the rotatable body, and the other end portion, which is opposite from the one end portion of the pedal arm and has a depressible portion that is depressible by a driver of the vehicle. The rotational angle sensing device senses a rotational angle of the shaft relative to the support member. The urging device is placed in the internal space and urges the shaft to rotate the shaft in the accelerator closing direction. The contact surface of the rotatable body is a curved surface.

### BRIEF DESCRIPTION OF THE DRAWINGS

The drawings described herein are for illustration purposes only and are not intended to limit the scope of the present disclosure in any way.

FIG. 1 is a side view of an accelerator apparatus according to an embodiment of the present disclosure;

FIG. 2 is a view taken in a direction of an arrow II in FIG. 1;

FIG. 3 is a cross-sectional view taken along line III-III in FIG. 2;

FIG. 4 is a cross-sectional view taken along line IV-IV in FIG. 3;

FIG. 5 is a partial enlarged view of an area V in FIG. 3;

FIG. 6 is a cross-sectional view taken along line VI-VI in FIG. 3;

FIG. 7A is a schematic view showing a positional relationship between a manipulation member and an inner wall of a rear segment of a housing in the accelerator apparatus of the embodiment in an initial state;

FIG. 7B is a schematic view showing a positional relationship between the manipulation member and the inner wall of the rear segment of the housing in the accelerator apparatus of FIG. 7A after a long-term use;

FIG. 8A is a schematic view, which is taken from a front side of the accelerator apparatus of the embodiment;

FIG. 8B is a schematic view, which is taken from an upper side of the accelerator apparatus along line VIIIB-VIIIB in FIG. 8A;

FIG. 9 is a characteristic diagram describing a relationship between a pedal force and a rotational angle at the accelerator apparatus of the embodiment;

FIG. 10A is a schematic view, which shows a positional relationship between a manipulation member and an inner wall of a rear segment of a housing in an accelerator apparatus of a comparative example in an initial state;

FIG. 10B is a schematic view, which shows the positional relationship between the manipulation member and the inner wall of the rear segment in the accelerator apparatus of the comparative example after long-term use;

FIG. 11A is a schematic view, which is taken from a front side of the accelerator apparatus of the comparative example and shows a positional relationship between a shaft and bearings at the time of depressing an accelerator pedal; and

FIG. 11B is a schematic cross-sectional view, which is taken from an upper side of the accelerator apparatus of the comparative example along line XIB-XIB in FIG. 11A.

### DETAILED DESCRIPTION

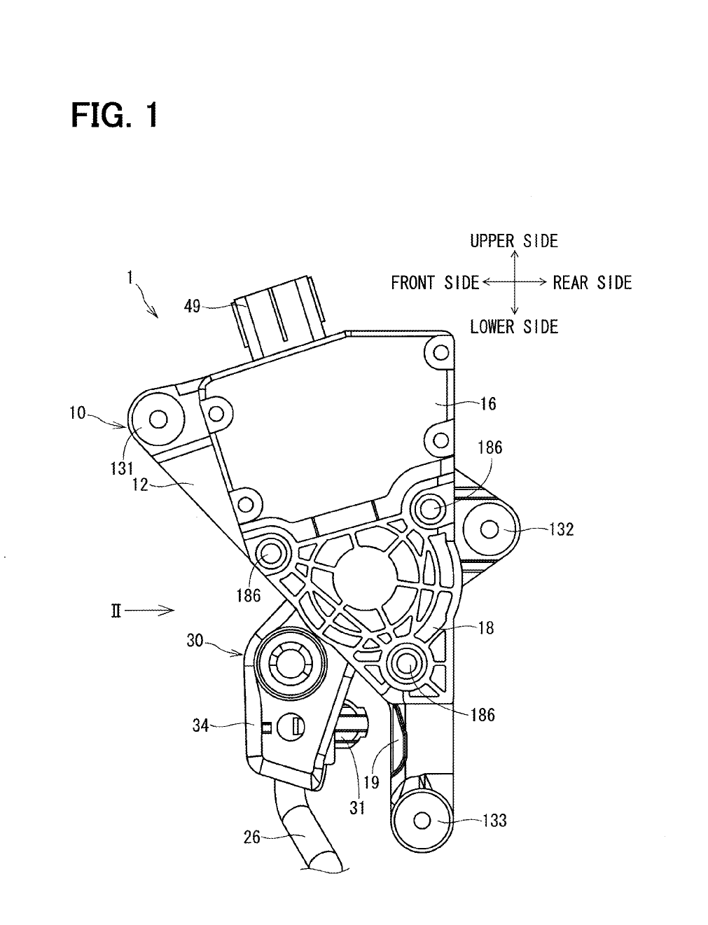

An embodiment of the present disclosure will be described with reference to FIGS. 1 to 6. The accelerator apparatus 1 is an input apparatus, which is manipulated by a driver of a vehicle (automobile) to determine a valve opening degree of a throttle valve of an internal combustion engine of the vehicle. The accelerator apparatus 1 is an electronic accelerator apparatus that outputs an electric signal, which indicates the amount of depression of an accelerator pedal (serving as a depressible portion) 28, to an electronic control device. The electronic control device drives the throttle valve through a throttle actuator (not shown) based on the amount of depression of the accelerator pedal 28 and the other information.

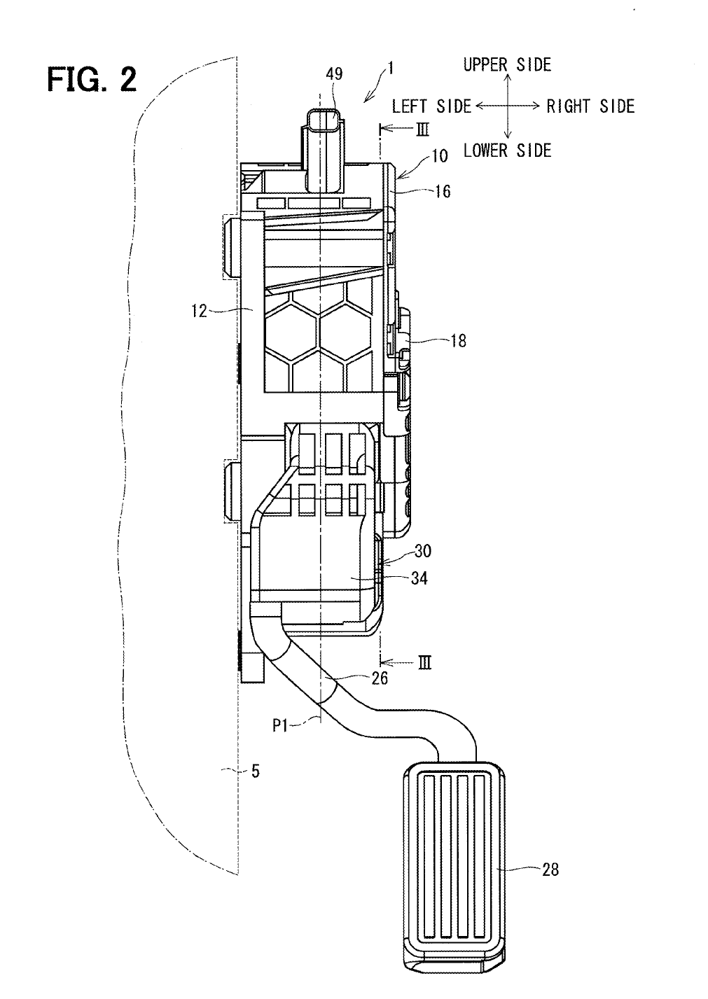

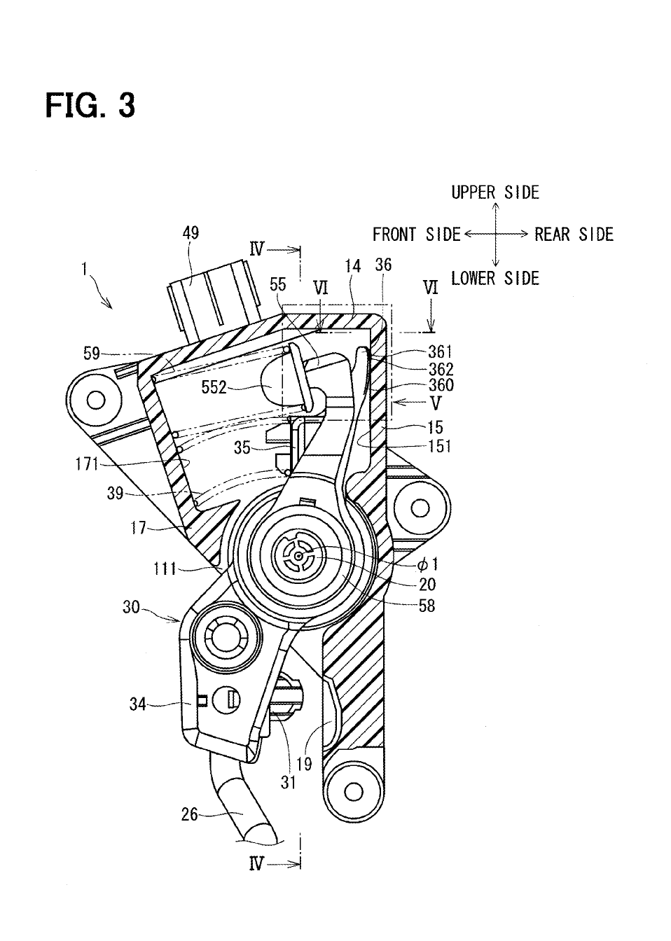

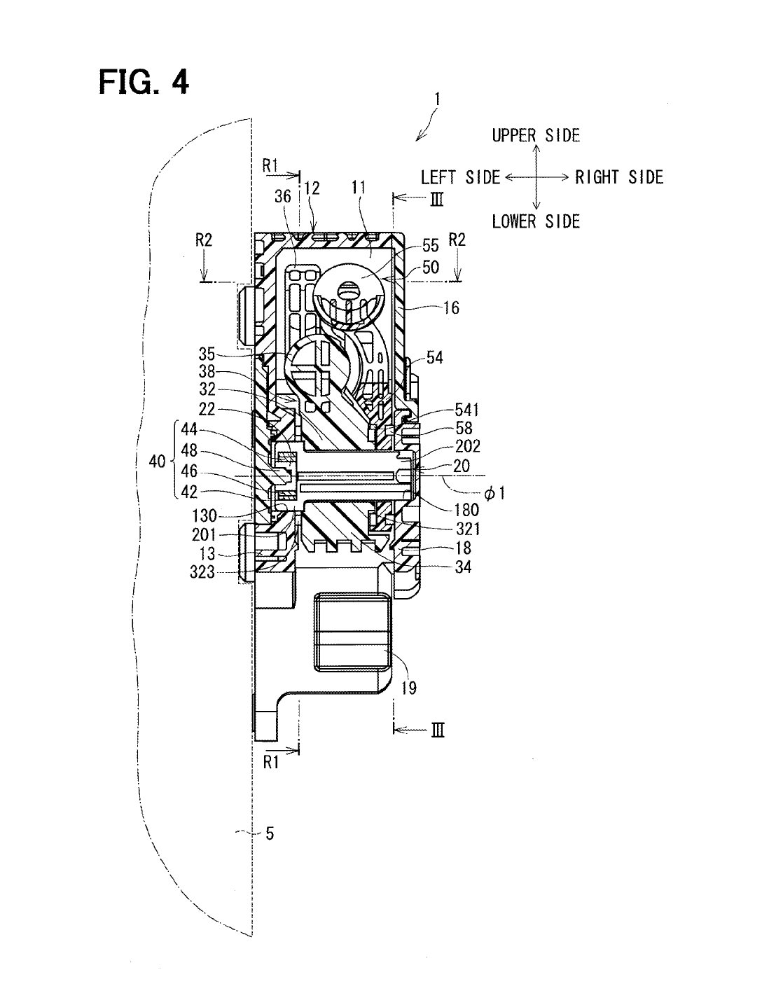

The accelerator apparatus 1 includes a support member 10, a shaft 20, a manipulation member 30, a return spring (serving as an urging device) 39, a rotational angle sensor (serving as a rotational angle sensing device) 40 and a hysteresis mechanism 50. In the following description, an upper side of FIGS. 1 to 4 will be described as an upper side of the accelerator apparatus 1, and a lower side of FIGS. 1 to 4 will be described as a lower side of the accelerator apparatus 1. A left side of FIGS. 1 and 3 will be referred to as a front side of the accelerator apparatus 1, and a right side of FIGS. 1 and 3 will be referred to as a rear side of the accelerator apparatus 1. Furthermore, a left side of FIGS. 2 and 4 will be referred to as a left side of the accelerator apparatus 1, and a right side of FIGS. 2 and 4 will be referred to as a right side of the accelerator apparatus 1.

The support member 10 includes a housing 12, a first cover 16 and a second cover 18. The support member 10 forms an internal space 11, which receives the shaft 20, the return spring 39, the rotational angle sensor 40 and the hysteresis mechanism 50. A communication hole 111 is formed at a lower portion of the support member 10 to communicate between the internal space 11 of the support member 10 and an external space of the support member 10. The communication hole 111 corresponds to a movable range of the manipulation member 30, which will be described later.

The housing 12 is made of a resin material and includes a bearing segment 13, a front segment 17, a rear segment 15 and a top segment 14. The bearing segment 13 rotatably supports one end portion 201 of the shaft 20. The front segment 17 is connected to the bearing segment 13 and is located at a front side of the accelerator apparatus 1. The rear segment 15 is opposed to the front segment 17. The top segment 14 is located at a top side of the accelerator apparatus 1 and connects between the front segment 17 and the rear segment 15. Ridges and recesses, which are alternately arranged and are configured into a mesh pattern, are formed in an outer wall of the bearing segment 13, an outer wall of the front segment 17, an outer wall of the rear segment 15 and an outer wall of the top segment 14 to maintain the resistivity of the housing 12 against an external force applied to the housing 12.

The bearing segment 13 has an opening, which receives the one end portion 201 of the shaft 20. The one end portion 201 of the shaft 20 is rotatably received in this opening of the bearing segment 13. Specifically, the inner wall of the opening of the bearing segment 13 forms a bearing 130, which rotatably supports the one end portion 201, and a gap is formed between the inner wall of the bearing 130 and the outer peripheral wall of the shaft 20.

As shown in FIG. 1, installation portions 131, 132, 133 are formed in the housing 12. A bolt hole is formed in each of the installation portions 131, 132, 133. The accelerator apparatus 1 is installed to a body 5 of the vehicle by bolts, which are received through the bolt holes, respectively, of the installation portions 131, 132, 133.

A full-opening-side stopper portion 19, which is a recess, is formed in the lower side of the rear segment 15. When a full-opening-side stopper 31, which is formed as a protrusion in the manipulation member 30, contacts the full-opening-side stopper portion 19, the rotation of the manipulation member 30 is stopped at an accelerator-full-opening position. The accelerator-full-opening position is a position, at which the amount of depression of the manipulation member 30 by the driver is in the full amount, i.e., the accelerator opening degree is 100% (full opening).

The first cover 16 and the second cover 18 are generally parallel to the bearing segment 13. The first cover 16 is configured into a rectangular plate form and is engaged to the second cover 18 such that the first cover 16 contacts an end portion of the top segment 14, an end portion of the rear segment 15 and an end portion of the front segment 17, which are opposite from the bearing segment 13 in the axial direction of the shaft 20. The first cover 16 limits intrusion of foreign objects into the internal space 11.

The second cover 18 is configured into a triangular plate form and is fixed with bolts 186 to the end portion of the rear segment 15, the end portion of the front segment 17 and the end portion of the front segment 17, which are opposite from the bearing segment 13 in the axial direction of the shaft 20. A recess, which rotatably supports the other end portion 202 of the shaft 20, is formed in an inner wall of the second cover 18. Specifically, the inner wall of the recess of the second cover 18 forms a bearing 180, which rotatably supports the other end portion 202 of the shaft 20, and a gap is formed between the inner wall of the bearing 180 and the outer peripheral wall of the shaft 20. Recesses and ridges, which are alternately arranged and are configured into a mesh pattern, are formed in an outer wall of the second cover 18 to maintain the resistivity of the second cover 18 against an external force applied to the second cover 18. The second cover 18 limits intrusion of foreign objects into the internal space 11.

The shaft 20 extends in a horizontal direction (the left-to-right direction of the vehicle) at the lower side of the accelerator apparatus 1. A sensor receiving recess 22 is formed in the one end portion 201 of the shaft 20 to receive a sensing device of the rotational angle sensor 40.

The shaft 20 is rotatable through a predetermined angular range from an accelerator-full-closing position to an accelerator-full-opening position in response to a torque, which is applied from the manipulation member 30 upon depressing of the manipulation member 30 by a foot of the driver. The accelerator-full-closing position is a position, at which the amount of depression of the manipulation member 30 by the foot of the driver is zero, i.e., the accelerator opening degree is 0% (full closing).

Hereinafter, the rotational direction of the manipulation member 30 from the accelerator-full-closing position toward the accelerator-full-opening position will be referred to an accelerator opening direction. Furthermore, the rotational direction of the manipulation member 30 from the accelerator-full-opening position toward the accelerator-full-closing position will be referred to an accelerator closing direction.

The manipulation member 30 includes a rotatable body 38, an accelerator pedal 28 and a pedal arm 26. The rotatable body 38 includes a boss portion 32, an arm connecting portion 34, a spring receiving portion 35 and a full-closing-side stopper portion 36, which are formed integrally.

The boss portion 32 is configured into an annular form (i.e., a cylindrical tubular form) and is fixed to an outer peripheral wall of the shaft 20 by, for example, press-fitting at a location between the bearing segment 13 and the second cover 18.

First-bevel-gear teeth 321 are formed integrally with a side surface of the boss portion 32, which is located on the second cover 18 side. The first-bevel-gear teeth 321 are arranged one after another at generally equal intervals in the circumferential direction. An axial projecting length of each of the first-bevel-gear teeth 321, which project toward a rotor 54 of the hysteresis mechanism 50, circumferentially progressively increases in the accelerator closing direction. Furthermore, a sloped surface is formed in a distal end part of each of the first-bevel-gear teeth 321 such that the sloped surface of each of the first-bevel-gear teeth 321 progressively approaches the rotor 54 in the accelerator closing direction.

A first friction member 323 is formed in a side surface of the boss portion 32, which is located on the housing 12 side. The first friction member 323 is configured into an annular form and is placed between the boss portion 32 and the inner wall of the housing 12 on a radially outer side of the shaft 20. When the boss portion 32 is urged in a direction away from the rotor 54, i.e., in a direction toward the bearing segment 13, the boss portion 32 frictionally engages the first friction member 323. The frictional force between the boss portion 32 and the first friction member 323 acts as a rotational resistance force (or simply referred to as a rotational resistance) against the rotation of the boss portion 32.

One end part of the arm connecting portion 34 is connected to an outer surface of the boss portion 32, which is located at a radially outer side, and the other end part of the arm connecting portion 34 extends to the outside of the support member 10 through the communication hole 111.

The spring receiving portion 35 is formed to extend from the boss portion 32 toward the upper side in the internal space 11. One end of the return spring 39 is engaged with the spring receiving portion 35.

The full-closing-side stopper portion 36 is located on a radial side of the shaft 20, which is opposite from the pedal arm 26 in a radial direction of the shaft 20. The full-closing-side stopper portion 36 extends from the spring receiving portion 35 toward the upper side in the internal space 11. The full-closing-side stopper portion (serving as a limiting portion) 36 limits rotation of the manipulation member 30 in the accelerator closing direction when the full-closing-side stopper portion 36 contacts the inner wall 151 of the rear segment 15. Details of the configuration of the full-closing-side stopper portion 36 will be described later.

As shown in FIG. 2, one end portion of the pedal arm 26 is fixed to the arm connecting portion 34, and the other end portion of the pedal arm 26 downwardly extends toward the ground (the lower side). In the accelerator apparatus 1 of the first embodiment, the pedal arm 26 extends downward and also projects from the housing 12 side of the arm connecting portion 34 such that the pedal arm 26 is connected to the accelerator pedal 28, which is provided at the right side of the accelerator apparatus 1. The accelerator pedal 28 converts the pedal force of the driver into a rotational torque, which is exerted about a rotational axis φ1 of the shaft 20, and this rotational torque is conducted to the shaft 20 through the rotatable body 38.

When the accelerator pedal 28 is rotated in the accelerator opening direction, a rotational angle of the shaft 20 in the accelerator opening direction relative to the accelerator-full-closing position, which serves as a reference point, is increased. Thereby, the accelerator opening degree, which corresponds to this rotational angle, is also increased. Furthermore, when the accelerator pedal 28 is rotated in the accelerator closing direction, the rotational angle of the shaft 20 is reduced, and thereby the accelerator opening degree is reduced.

The return spring 39 is made of a coil spring, and the other end of the return spring 39 is engaged with an inner wall 171 of the front segment 17. The return spring 39, which serves as an urging device (an urging means), urges the manipulation member 30 in the accelerator closing direction. The urging force, which is exerted from the return spring 39 to the manipulation member 30, is increased when the rotational angle of the manipulation member 30, i.e., the rotational angle of the shaft 20 is increased. Furthermore, this urging force is set to enable returning of the manipulation member 30 and the shaft 20 to the accelerator-full-closing position regardless of the rotational position of the manipulation member 30.

The rotational angle sensor 40 includes a yoke 42, two permanent magnets (the permanent magnets having different polarities, respectively) 44, 46 and a Hall element 48. The yoke 42 is made of a magnetic material and is configured into a tubular form. The yoke 42 is fixed to an inner wall of the sensor receiving recess 22 of the shaft 20. The magnets 44, 46 are placed radially inward of the yoke 42 and are fixed to the inner wall of the yoke 42 such that the magnets 44, 46 are opposed to each other about the rotational axis φ1 of the shaft 20. The Hall element 48 is placed between the magnet 44 and the magnet 46. The rotational angle sensor 40 serves as a rotational angle sensing device (a rotational angle sensing means) of the present disclosure.

When a magnetic field is applied to the Hall element 48, through which an electric current flows, a voltage is generated in the Hall element 48. This phenomenon is referred to as a Hall effect. A density of a magnetic flux, which penetrates through the Hall element 48, changes when the shaft 20 and the magnets 44, 46 are rotated about the rotational axis φ1 of the shaft 20. A value of the voltage discussed above is substantially proportional to the density of the magnetic flux, which penetrates through the Hall element 48. The rotational angle sensor 40 senses the relative rotational angle between the Hall element 48 and the magnets 44, 46, i.e., the relative rotational angle of the shaft 20 relative to the support member 10 by sensing the voltage, which is generated in the Hall element 48. The rotational angle sensor 40 transmits an electrical signal, which indicates the sensed rotational angle, to the external electronic device (not shown) through a connector 49 that is provided in the upper part of the accelerator apparatus 1.

The hysteresis mechanism 50 includes the rotor 54, a second friction member 58 and a hysteresis spring 59.

The rotor 54 is provided between the boss portion 32 and the inner wall of the second cover 18 at a location, which is on a radially outer side of the shaft 20. The rotor 54 is configured into an annular form. The rotor 54 is rotatable relative to the shaft 20 and the boss portion 32 and can be moved toward or away from the boss portion 32. Second-bevel-gear teeth 541 are formed integrally with a side surface of the rotor 54, which is located on the boss portion 32 side. The second-bevel-gear teeth 541 are arranged one after another at generally equal intervals in the circumferential direction. An axial projecting length of each of the second-bevel-gear teeth 541, which projects toward the boss portion 32, circumferentially progressively increases in the accelerator opening direction. Furthermore, a sloped surface is formed in a distal end part of each of the second-bevel-gear teeth 541 such that the sloped surface of each of the second-bevel-gear teeth 541 progressively approaches the rotor 54 in the accelerator opening direction.

When each of the first-bevel-gear teeth 321 contacts the corresponding one of the second-bevel-gear teeth 541 in the circumferential direction, the rotation can be transmitted between the boss portion 32 and the rotor 54. That is, the rotation of the boss portion 32 in the accelerator opening direction can be transmitted to the rotor 54 thorough the first-bevel-gear teeth 321 and the second-bevel-gear teeth 541. Furthermore, the rotation of the rotor 54 in the accelerator closing direction can be transmitted to the boss portion 32 through the second-bevel-gear teeth 541 and the first-bevel-gear teeth 321.

Furthermore, the sloped surface of each of the first-bevel-gear teeth 321 and the sloped surface of the corresponding one of the second-bevel-gear teeth 541 are engaged with each other and displace the boss portion 32 and the rotor 54 away from each other when the rotational position of the boss portion 32 is on the accelerator-full-opening position side of the accelerator-full-closing position. At this time, the first-bevel-gear teeth 321 urge the boss portion 32 toward the housing 12 by the urging force, which increases when the rotational angle of the boss portion 32 from the accelerator-full-closing position is increased. Furthermore, the second-bevel-gear teeth 541 urge the boss portion 32 toward the second cover 18 by the urging force, which increases when the rotational angle of the boss portion 32 from the accelerator-full-closing position is increased.

The second friction member 58 is configured into an annular form and is placed between the rotor 54 and the inner wall of the second cover 18 on the radially outer side of the shaft 20. When the rotor 54 is urged in the direction away from the boss portion 32, i.e., in the direction toward the second cover 18, the rotor 54 is frictionally engaged with the second friction member 58. The frictional force between the rotor 54 and the second friction member 58 acts as the rotational resistance force (or simply referred to as a rotational resistance) against the rotation of the rotor 54.

The hysteresis spring 59 is formed by a coil spring. One end of the hysteresis spring 59 is engaged with the spring receiving member 552, which is engaged with a spring engaging portion 55 that is formed to extend upward from the rotor 54 in the internal space 11, and the other end of the hysteresis spring 59 is engaged with the inner wall 171 of the front segment 17. The hysteresis spring 59 urges the rotor 54 in the accelerator closing direction. The urging force of the hysteresis spring 59 is increased when the rotational angle of the rotor 54 is increased. The torque, which is applied to the rotor 54 by the urging force of the hysteresis spring 59, is conducted to the boss portion 32 through the second-bevel-gear teeth 541 and the first-bevel-gear teeth 321.

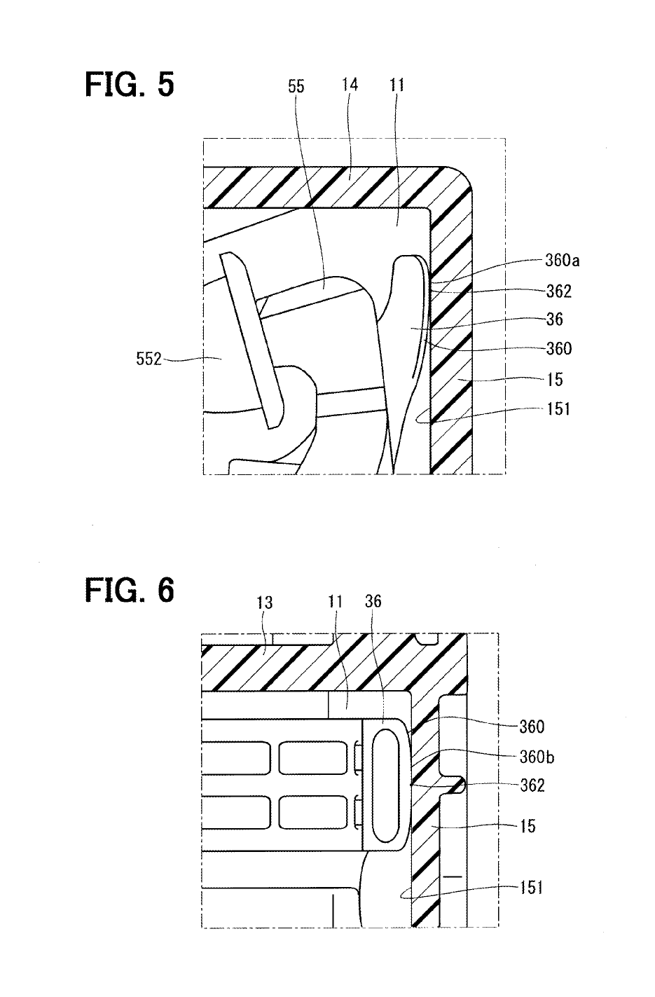

Here, in the accelerator apparatus 1 of the present embodiment, the shape of the full-closing-side stopper portion 36 has the characteristic feature. This feature will be described in detail with reference to FIGS. 5 to 7B.

FIG. 5 is a partial enlarged view of an area V in FIG. 3. That is, FIG. 5 is a cross-sectional view of the accelerator apparatus 1 taken from the lateral side in the state where the full-closing-side stopper portion 36 contacts the inner wall 151 of the rear segment 15. As shown in FIG. 5, a contact surface 360 of the full-closing-side stopper portion 36 is configured as an arcuate surface (curved surface), which makes a point contact with a planar surface of the inner wall 151. Specifically, in this embodiment, the contact surface 360 of the full-closing-side stopper portion 36 is defined relative to a plane (imaginary plane) that is perpendicular to the rotational axis φ1 of the shaft 20 and extends along line R1-R1 in FIG. 4 through a contact point of the contact surface 360, which contacts the inner wall 151. The contact surface 360 forms an arcuate line 360a of intersection between the contact surface 360 and the-above described plane (the imaginary plane), which is perpendicular to the rotational axis φ1 of the shaft 20.

FIG. 6 is a cross-sectional view, which is taken along line VI-VI in FIG. 3 and is seen from the top side. FIG. 6 shows a state where the full-closing-side stopper portion 36 contacts the inner wall 151 of the rear segment 15. As shown in FIG. 6, the contact surface 360 is configured as the arcuate surface that makes the point contact with the planar surface of the inner wall 151. The contact surface 360 of the full-closing-side stopper portion 36 is defined relative to another plane (imaginary plane) that is parallel to the rotational axis φ1 of the shaft 20 and extends along line R2-R2 in FIG. 4 through the contact point of the contact surface 360, which contacts the inner wall 151. The contact surface 360 forms an arcuate line 360b of intersection between the contact surface 360 and the-above described plane (the imaginary plane), which is parallel to the rotational axis φ1 of the shaft 20.

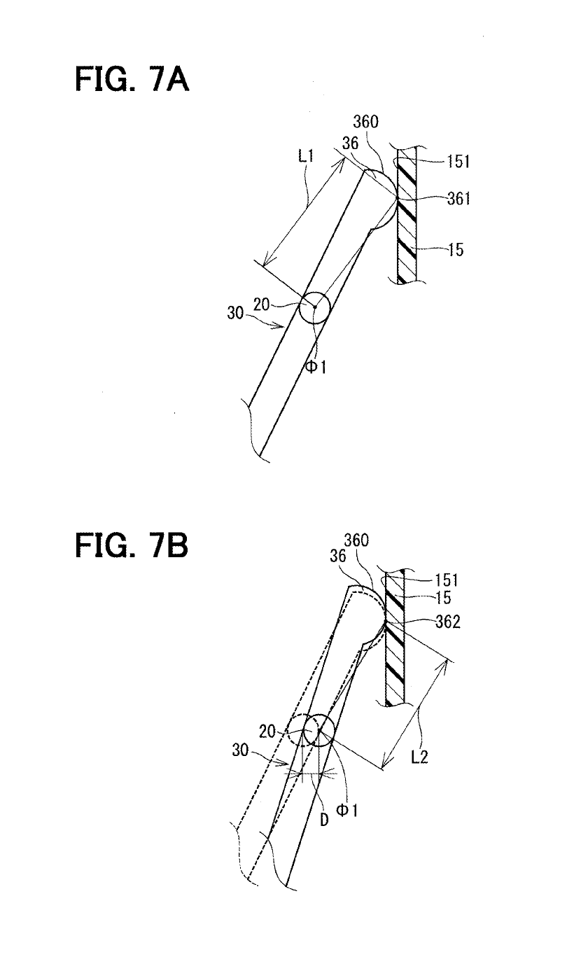

Because of the above-described shape of the contact surface 360, the rotation of the rotatable body 38 in the accelerator closing direction is limited when a second contact point 362 (or a first contact point 361 shown in FIG. 7), which is located along the contact surface 360, contacts the inner wall 151 at the accelerator-full-closing time, which is the time of placing the manipulation member 30 in the accelerator-full-closing position.

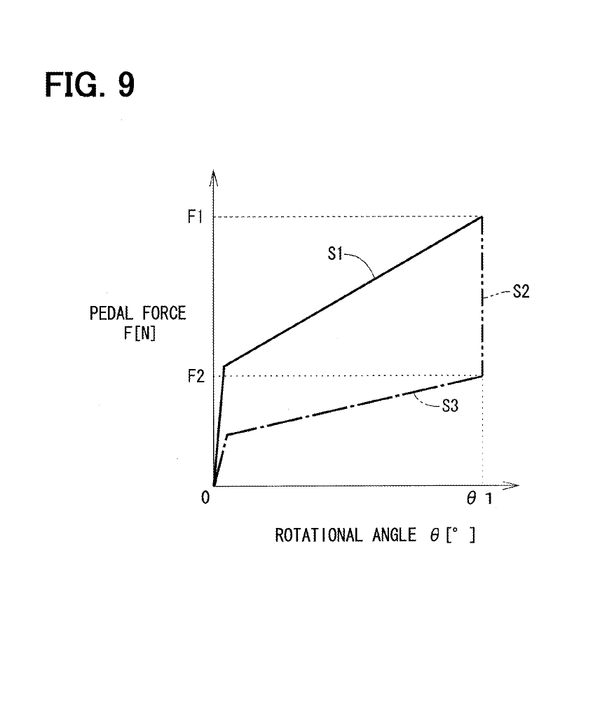

Next, the operation of the accelerator apparatus 1 will be described with reference to FIG. 9.

When the accelerator pedal 28 is depressed by the foot of the driver, the manipulation member 30 is rotated together with the shaft 20 in the accelerator opening direction about the rotational axis φ1 of the shaft 20 in response to the pedal force of the driver applied to the accelerator pedal 28. At this time, in order to rotate the manipulation member 30 and the shaft 20, there is required a pedal force, which generates a torque that is larger than a sum of a torque, which is exerted by the urging force of the return spring 39 and the urging force of the hysteresis spring 59, and a resistance torque, which is exerted by the frictional force of the first friction member 232 and the second friction member 58.

When the accelerator pedal 28 is depressed, the resistance torque, which is exerted by the frictional force of the first friction member 323 and the frictional force of the second friction member 58, acts to limit the rotation of the accelerator pedal 28 in the accelerator opening direction. Therefore, with reference to FIG. 9, the pedal force F at the time of depressing the accelerator pedal 28 (see a solid line S1, which indicates the relationship between the pedal force F and the rotational angle θ at the time of depressing the accelerator pedal 28) is larger than the pedal force F at the time of returning the accelerator pedal 28 toward the accelerator-full-closing position (see a dot-dash line S3, which indicates the relationship between the pedal force F and the rotational angle θ at the time of returning the accelerator pedal 28 toward the accelerator-full-closing position) even for the same rotational angle θ.

In order to maintain the depressed state of the accelerator pedal 28, it is only required to apply the pedal force that generates the torque, which is larger than a difference between the torque generated by the urging forces of the return spring 39 and the hysteresis spring 59 and the resistance torque generated by the frictional forces of the first and second friction members 323, 58. In other words, when the driver wants to maintain the depressed state of the accelerator pedal 28 after depressing the accelerator pedal 28, the driver may reduce the applied pedal force by a certain amount.

For example, as indicated by a dot-dot-dash line S2 in FIG. 9, in the case where the depressed state of the accelerator pedal 28, which is depressed to the rotational angle θ1, needs to be maintained, the pedal force may be reduced from the pedal force F1 to the pedal force F2. In this way, the depressed state of the accelerator pedal 28 can be easily maintained. The resistance torque, which is generated by the frictional forces of the first and second friction members 323, 58, is exerted to limit the rotation of the accelerator pedal 28 in the accelerator closing direction at the time of maintaining the depressed state of the accelerator pedal 28.

In order to return the accelerator pedal 28 to the accelerator-full-closing position, the pedal force applied to the accelerator pedal 28 should generate a torque that is smaller than the difference between the torque, which is generated by the urging forces of the return spring 39 and the hysteresis spring 59, and the resistance torque, which is generated by the frictional forces of the first and second friction members 323, 58. Here, at the time of returning the accelerator pedal 28 to the accelerator-full-closing position, it is only required to stop the depressing of the accelerator pedal 28. Therefore, there is no substantial burden on the driver. In contrast, when the accelerator pedal 28 is gradually returned toward the accelerator-full-closing position, it is required to apply a predetermined pedal force on the accelerator pedal 28. In the present embodiment, the pedal force, which is required to gradually return the accelerator pedal 28 toward the accelerator-full-closing position, is relatively small.

For example, as indicated by the dot-dash line S3 in FIG. 9, in the case where the accelerator pedal 28, which is depressed to the rotational angle θ1, is gradually returned toward the accelerator-full-closing position, the pedal force may be adjusted between the pedal force F2 and 0 (zero). The pedal force F2 is smaller than the pedal force F1. Therefore, when the depressed accelerator pedal 28 is returned toward the accelerator-full closing position, the burden on the driver is reduced. The resistance torque, which is generated by the frictional forces of the first and second friction members 323, 58, is exerted to limit the rotation of the accelerator pedal 28 in the accelerator closing direction at the time of returning the accelerator pedal 28 toward the accelerator-full closing position. Therefore, as indicated in FIG. 9, the pedal force F at the time of returning the accelerator pedal 28 toward the accelerator-full-closing position (see the dot-dash line S3, which indicates the relationship between the pedal force F and the rotational angle θ at the time of returning the accelerator pedal 28 toward the accelerator-full-closing position) is smaller than the pedal force F at the time of depressing the accelerator pedal 28 (see the solid line S1, which indicates the relationship between the pedal force F and the rotational angle θ at the time of depressing the accelerator pedal 28) even for the same rotational angle θ.

At the time of manipulating the accelerator pedal 28 of the accelerator apparatus 1, it could happen that the accelerator pedal 28 is returned to the accelerator-full-closing position while the rotational axis φ1 of the shaft 20 is deviated from the position of the rotational axis φ1 before use of the accelerator apparatus 1 (e.g., a brand-new state of the accelerator apparatus 1). Hereinafter, the phenomenon of the deviation of the rotational axis φ1 of the shaft 20 will be described along with the effects and the advantages of the accelerator apparatus 1 of the embodiment with reference to FIGS. 7A to 8B and 10A to 11B in comparison to an accelerator apparatus of a comparative example.

FIGS. 7A and 7B are schematic cross-sectional views taken from the side of the accelerator apparatus 1, showing positional relationships between the manipulation member 30 and the inner wall 151 of the rear segment 15 at the accelerator-full-closing time. Specifically, FIG. 7A shows a positional relationship between the manipulation member 30 and the inner wall 151 of the rear segment 15 in the accelerator apparatus 1 before the use of the accelerator apparatus 1, i.e., in an initial state of the accelerator apparatus 1 (e.g., a brand-new state of the accelerator apparatus 1). Furthermore, FIG. 7B shows the positional relationship between the manipulation member 30 and the inner wall 151 of the rear segment 15 in the accelerator apparatus 1 after long-term use (after the actual long-term use or after an endurance test, which creates the situation similar to the actual long-term use). Here, the accelerator apparatus after the long-term use refers to the accelerator apparatus after the long-term use thereof, which involves a relatively large number of accelerator manipulations (manipulations of the manipulation member 30, i.e., repeated rotations of the manipulation members 30). A dotted line in FIG. 7B shows the positional relationship between the manipulation member 30 and the inner wall 151 of the rear segment 15 at the accelerator-full-closing time in the accelerator apparatus 1 of FIG. 7A in the initial state.

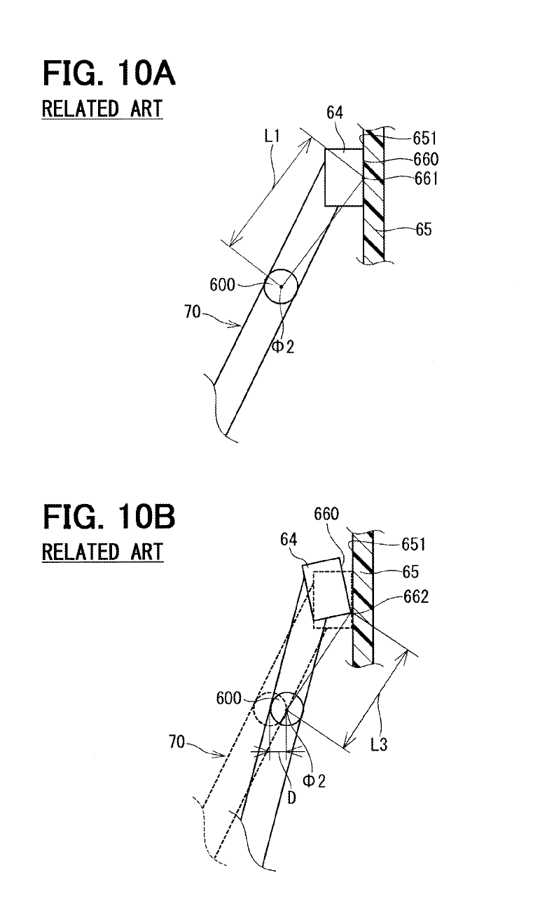

FIGS. 10A and 10B are schematic views of the accelerator apparatus of the comparative example, showing positional relationships between a manipulation member 70 in the accelerator-full-closing time and an inner wall 651 of a rear segment 65 of a housing. In the comparative example shown in FIGS. 10A and 10B, a contact surface 660 of the full-closing-side stopper portion 64 is a flat surface. Specifically, FIG. 10A shows the positional relationship between the manipulation member 70 and the inner wall 651 of the rear segment 65 in the accelerator apparatus of the comparative example in the initial state. Furthermore, FIG. 10B shows the positional relationship between the manipulation member 70 and the inner wall 651 of the rear segment 65 in the accelerator apparatus of the comparative example after the long-term use. A dotted line in FIG. 10B shows the positional relationship between the manipulation member 70 and the inner wall 651 of the rear segment 65 at the accelerator-full-closing time in the accelerator apparatus of FIG. 10A in the initial state.

In the accelerator apparatus 1 in the initial state, as shown in FIG. 7A, the first contact point 361 along the contact surface 360 contacts the inner wall 151. At this time, the rotational axis φ1 of the shaft 20 and the first contact point 361 are spaced from each other by a distance L1.

The bearing 130 of the housing 12 and the bearing 180 of the second cover 18, which support the shaft 20, may possibly have, for example, creep strain caused by the long-term use and wearing deformation caused by friction with the shaft 20. When the bearings 130, 180 are deformed, the rotational axis φ1 of the shaft 20 may be moved toward the rear segment 15 by a distance D, as shown in FIG. 7B. In the accelerator apparatus 1 after the long-term use, the second contact point 362, which is located adjacent to the first contact point 361 on the contact surface 360, contacts the inner wall 151 at the accelerator-full-closing time due to the movement of the rotational axis φ1. At this time, the rotational axis φ1 of the shaft 20 and the second contact point 362 are spaced from each other by a distance L2.

In contrast, in the accelerator apparatus of the comparative example, as shown in FIG. 10A, a third contact point 661, which is located substantially in the center of the contact surface 660, contacts the inner wall 651 of the rear segment 65. At this time, the rotational axis φ2 of the shaft 60 and the third contact point 661 are spaced from each other by the distance L1, which is substantially the same as the distance L1 of the accelerator apparatus 1 of the first embodiment shown in FIG. 7A.

Furthermore, in the case where the rotational axis φ2 of the shaft 60 is displaced by the distance D, which is the same as the distance D of the accelerator apparatus 1 of the first embodiment shown in FIG. 7B, due to the long-term use of the accelerator apparatus of the comparative example, a lower end part 662 of the contact surface 660 contacts the inner wall 651. At this time, the rotational axis φ2 of the shaft 60 and the lower end part 662 are spaced from each other by a distance L3. A difference (L1−L3) between the distance L1 and the distance L3 in the accelerator apparatus of the comparative example is larger than a difference between the distance L1 and the distance L2 in the accelerator apparatus 1 of the embodiment shown in FIGS. 7A and 7B. In the discussion of FIGS. 7A and 7B and the discussion of FIGS. 10A and 10B, there is described the case where the rotational axis of the shaft is moved toward the rear segment of the housing. However, the above discussion is equally applicable in a case where the rotational axis is moved toward the front segment of the housing.

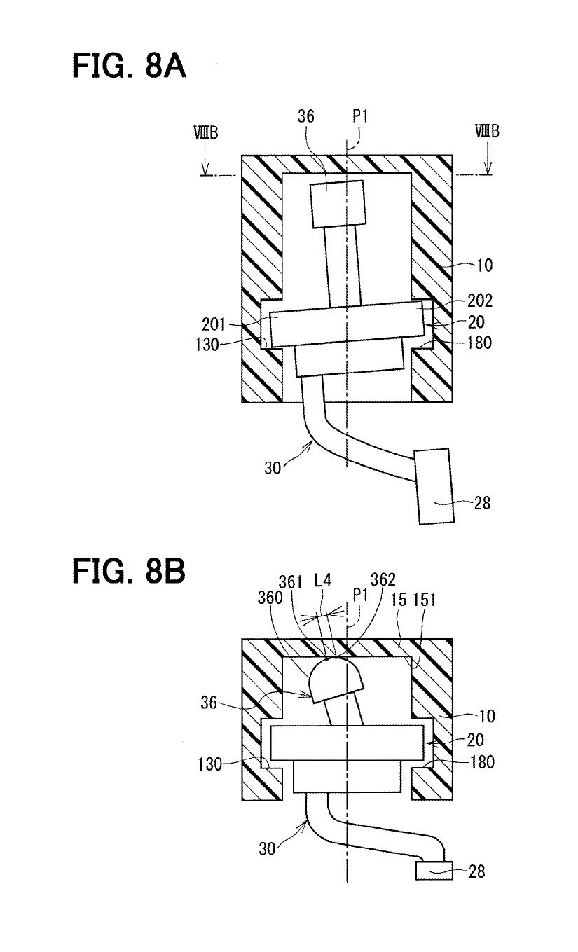

FIGS. 8A and 8B are schematic cross-sectional views showing positional relationships among the shaft 20, the manipulation member 30 and the inner wall 151 of the rear segment 15 at the accelerator-full-closing time of the accelerator apparatus 1 of the embodiment. More specifically, FIG. 8A is the schematic cross-sectional view, which is taken from the front side of the accelerator apparatus 1 and shows the positional relationship among the shaft 20 and the bearings 130, 180 at the time of depressing the accelerator pedal 28. Furthermore, FIG. 8B is the schematic cross-sectional view, which is taken from the upper side of the accelerator apparatus 1 and shows the positional relationship between the manipulation member 30 and the inner wall 151 of the rear segment 15 in the state where the accelerator pedal 28 is returned to the accelerator-full-closing position after depressing of the accelerator pedal 28. In FIGS. 8A and 8B, the tilt of the manipulation member 30 is exaggerated for the sake of easy understanding for the contact state of the contact surface 360.

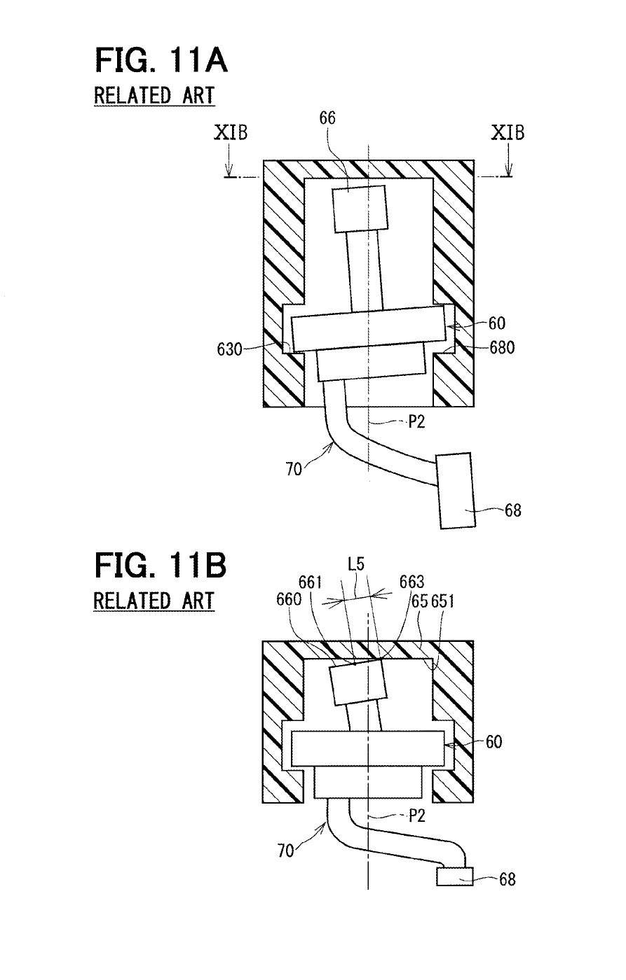

FIGS. 11A and 11B are schematic cross-sectional views showing positional relationships among the shaft 60, the manipulation member 70 and the inner wall 651 of the rear segment 65 at the accelerator-full-closing time of the accelerator apparatus of the comparative example. More specifically, FIG. 11A is the schematic cross-sectional view, which is taken from the front side of the accelerator apparatus of the comparative example and shows the positional relationship between the shaft 60 and the bearings 630, 680 at the time of depressing the accelerator pedal 68. Furthermore, FIG. 11B is the schematic cross-sectional view, which is taken from the upper side of the accelerator apparatus of the comparative example and shows the positional relationship between the manipulation member 70 and the inner wall 651 of the rear segment 65 in the state where the accelerator pedal 68 is returned to the accelerator-full-closing position after depressing of the accelerator pedal 68. In FIGS. 11A and 11B, the tilt of the manipulation member 70 is exaggerated for the sake of easy understanding for the contact state of the contact surface 660.

When the driver of the vehicle depresses the accelerator pedal 28, the shaft 20 may be tilted toward the left side or the right side upon application of the pedal force of the driver to the shaft 20 through the accelerator pedal 28. In the accelerator apparatus 1 of the first embodiment, the accelerator pedal 28 is offset from a center plane (imaginary plane) P1 of the accelerator apparatus 1 toward the right side. This center plane P1 may extend through an axial center (longitudinal center) of the shaft 20. As shown in FIG. 8A, the one end portion 201 of the shaft 20 thereby contacts a lower side part of the inner wall of the bearing 130. In contrast, the other end portion 202 of the shaft 20 contacts an upper side part of the bearing 180. Because of the above-described tilt of the shaft 20, the manipulation member 30 is rotated in the state where the manipulation member 30 is tilted relative to the center plane P1 of the accelerator apparatus 1.

At the accelerator-full-closing time of the accelerator apparatus 1, the manipulation member 30 is rotated in the state where the manipulation member 30 is tilted relative to the center plane P1 toward the left side, so that the contact surface 360 of the full-closing-side stopper portion 36 contacts the inner wall 151 at the second contact point 362 of the contact surface 360. The second contact point 362 is placed adjacent to the first contact point 361. The first contact point 361 and the second contact point 362 are spaced from each other by a distance L4.

In contrast, in the accelerator apparatus of the comparative example, at the accelerator-full-closing time, when the manipulation member 70 is tilted relative to a center plane (imaginary plane) P2 toward the left side due to the phenomenon similar to the one discussed with reference to FIGS. 8A and 8B, a right end part 663 of the contact surface 660 contacts the inner wall 651 of the rear segment 65. The third contact point 661 and the right end part 663 are spaced from each other by a distance L5, which is larger than the distance L4 in the accelerator apparatus 1 of the embodiment.

Furthermore, in the accelerator apparatus of the comparative example, after the occurrence of contacting of the right end part 663 to the inner wall 651 at the accelerator-full-closing time, the manipulation member 70 is rotated by an action of a return spring (not shown), and thereby the third contact point 661 contacts the inner wall 651.

In the discussion of FIGS. 8A and 8B as well as the discussion of FIGS. 11A and 11B, there is described the case where the accelerator pedal is offset from the center plane of the accelerator apparatus toward the right side. However, it is the same in a case where the accelerator pedal is offset from the center plane (or the center line) of the accelerator apparatus toward the left side.

(I) In the accelerator apparatus 1 of the embodiment, the contact surface 360 of the full-closing-side stopper portion 36 is configured as the arcuate surface (the curved surface). Therefore, even when the position of the rotational axis φ1 of the shaft 20 of the accelerator apparatus 1 is deviated due to various factors, the deviation of the position of the contact point (e.g., the difference between the first contact point 361 and the second contact point 362 shown in FIG. 8B) on the contact surface 360 can be reduced. In this way, the distance from the rotational axis φ1 of the shaft 20 to the contact point becomes stable, so that the rotational angle, which is sensed with the rotational angle sensor 40 at the accelerator-full-closing time, can be stabilized (i.e., enabling minimization of variations in the sensed rotational angle of the shaft 20).

(II) Furthermore, the distance from the contact point to the rotational axis φ1 of the shaft 20 at the accelerator-full-closing time is stabilized, so that it is possible to reduce the positional deviation of the accelerator pedal after the long-term use relative to the position of the accelerator pedal at the initial time. In this way, the position of the accelerator pedal 28 at the accelerator-full-closing time can be stabilized.

(III) In the previously proposed accelerator apparatus, when the end part of the contact surface contacts the inner wall of the rear segment of the housing at the accelerator-full-closing time, the accelerator apparatus is placed into the accelerator-full-closing position. Thereafter, the manipulation member is further rotated by the action of the return spring in the closing direction (the accelerator-full-closing direction) from the state where the end part of the contact surface of the full-closing-side stopper portion contacts the inner wall of the rear segment, so that the manipulation member is stably held in the accelerator-full-closing position. That is, in the accelerator apparatus, which has the full-closing-side stopper portion having the flat contact surface, the two rotational angles of the shaft may be sensed and recognized as the accelerator-full-closing position. Therefore, the pedal force electric characteristic, which indicates the relationship between the rotational angle of the shaft and the voltage outputted from the rotational angle sensor, will have a deficiency (an error).

In the accelerator apparatus 1 of the present embodiment, when the second contact point 362 of the contact surface 360 of the full-closing-side stopper portion 36 contacts the inner wall 151 at the accelerator-full-closing time, the manipulation member 30 is placed in the actual accelerator full-closing position, and thereby the manipulation member 30 is no longer rotated in the closing direction (the accelerator-full-closing direction). In this way, the occurrence of the deficiency in the pedal force electric characteristic can be limited.

(IV) The full-closing-side stopper portion 36 is placed at the position, which is relatively far from the rotational axis φ1 of the shaft 20. Therefore, the arcuate shape of the contact surface 360 can be applied to the full-closing-side stopper portion 36, which has the relatively thin wall.

Now, modifications of the above embodiment will be described.

In the above embodiment, the contact surface 360 of the full-closing-side stopper portion 36 is configured such that the line of intersection between the contact surface of the full-closing-side stopper portion and the plane (the imaginary plane), which extends along the line R1-R1 in FIG. 4 and is perpendicular to the rotational axis φ1 of the shaft 20, is the arcuate line 360a. Furthermore, in the above embodiment, the contact surface 360 of the full-closing-side stopper portion 36 is configured such that the line of intersection between the contact surface of the full-closing-side stopper portion and the plane (the imaginary plane), which extends along the line R2-R2 and is parallel to the rotational axis φ1 of the shaft 20, is the arcuate line 360b. However, the configurations of the lines of intersections discussed above are not limited to the above-described ones. For example, the contact surface of the full-closing-side stopper portion may be configured such that only the line of intersection between the contact surface of the full-closing-side stopper portion and the plane, which is perpendicular to the rotational axis of the shaft, is the arcuate line. Alternatively, the contact surface of the full-closing-side stopper portion may be configured such that only the line of intersection between the contact surface of the full-closing-side stopper portion and the plane, which is parallel to the rotational axis of the shaft, is the arcuate line.

In the above embodiment, the contact surface of the full-closing-side stopper portion is configured such that the line of intersection between the contact surface of the full-closing-side stopper portion and the plane, which is perpendicular to the rotational axis of the shaft, is the arcuate line. Furthermore, in the above embodiment, the contact surface of the full-closing-side stopper portion is configured such that the line of intersection between the contact surface of the full-closing-side stopper portion and the plane (the imaginary plane), which is parallel to the rotational axis of the shaft, is the arcuate line. In this instance, it is not absolutely necessary to set a radius of the arc of the line of intersection between the contact surface of the full-closing-side stopper portion and the plane, which is perpendicular to the rotational axis of the shaft, to be equal to a radius of the arc of the line of intersection between the contact surface of the full-closing-side stopper portion and the plane (the imaginary plane), which is parallel to the rotational axis of the shaft. That is, the radius of the arc of the line of intersection between the contact surface of the full-closing-side stopper portion and the plane, which is perpendicular to the rotational axis of the shaft, may be different from the radius of the arc of the line of intersection between the contact surface of the full-closing-side stopper portion and the plane, which is parallel to the rotational axis of the shaft. Alternatively, these radii of the arcs may be substantially equal to each other.

In the above embodiment, the accelerator apparatus has the hysteresis mechanism. However, it may not be necessary to have the hysteresis mechanism in the accelerator apparatus.

In the above embodiment, the accelerator pedal is entirely placed on the one side of the imaginary center plane (see FIGS. 8A and 8B), which extends through the axial center of the shaft in the direction perpendicular to the rotational axis of the shaft, and the contact surface of the limiting portion is at least partially placed on the other side of the imaginary center plane, which is opposite from the one side. Alternatively, the contact surface (or the contact point of the contact surface) of the limiting portion may be entirely placed on the other side of the imaginary center plane. Also, if desired, it is possible to place the contact surface of the limiting portion on the one side of the imaginary center plane.

The present disclosure is not limited to the above embodiment and modifications thereof, and the above embodiment may be further modified within the spirit and scope of the present disclosure.

What is claimed is:

1. An accelerator apparatus for a vehicle, comprising:
a support member that is installable to a body of the vehicle;
a shaft that is rotatably supported by the support member;
a rotatable body that is rotatable integrally with the shaft and includes:
a boss portion, which is fixed to an outer peripheral wall of the shaft; and
a limiting portion, which is received in an internal space of the support member and is connected to the boss portion, wherein the limiting portion limits a rotational angle of the boss portion in an accelerator closing direction when a contact surface of the limiting portion contacts an inner wall of the support member at an accelerator-full-closing time;
a pedal arm that has one end portion, which is fixed to the rotatable body, and the other end portion, which is opposite from the one end portion of the pedal arm and has a depressible portion that is depressible by a driver of the vehicle;
a rotational angle sensing device that senses a rotational angle of the shaft relative to the support member; and
an urging device that is placed in the internal space and urges the shaft to rotate the shaft in the accelerator closing direction, wherein the contact surface of the rotatable body is a curved surface.

2. The accelerator apparatus according to claim 1, wherein the contact surface of the rotatable body is configured to form an arcuate line of intersection between the contact surface and an imaginary plane, which is perpendicular to a rotational axis of the shaft.

3. The accelerator apparatus according to claim 1, wherein the contact surface of the rotatable body is configured to form an arcuate line of intersection between the contact surface and an imaginary plane, which is parallel to a rotational axis of the shaft.

4. The accelerator apparatus according to claim 1, wherein the limiting portion is located on a radial side of the shaft, which is opposite from the pedal arm in a radial direction of the shaft.

5. The accelerator apparatus according to claim 1, wherein:
the urging device includes a spring, which has one end that is engaged with a spring engaging portion of the rotatable body; and
the limiting portion is located on a side of the spring engaging portion, which is opposite from the spring in a rotational direction of the rotatable body.

6. The accelerator apparatus according to claim 1, wherein:
the depressible portion is entirely placed on one side of an imaginary center plane, which extends through an axial center of the shaft in a direction perpendicular to the rotational axis of the shaft; and
the contact surface of the limiting portion is at least partially placed on the other side of the imaginary center plane, which is opposite from the one side of the imaginary center plane.
